(19) United States
(12) Patent Application Publication
(10) Pub. No.: US 2020/0339025 A1
(43) Pub. Date: Oct. 29, 2020

(54) UNMANNED VENDING VEHICLE SYSTEM AND METHOD OF USE THEREOF

(71) Applicants: Chuan Yu, Guiyang (CN); Ming Zhang, Guiyang (CN)

(72) Inventors: Chuan Yu, Guiyang (CN); Ming Zhang, Guiyang (CN)

(21) Appl. No.: 16/530,950

(22) Filed: Aug. 2, 2019

(30) Foreign Application Priority Data
Apr. 23, 2019 (CN) 201910330812.5

(51) Int. Cl. B60P 3/025; G06Q 10/08; G06Q 50/28; G06Q 50/10; G01S 13/88; G05D 1/02

(52) U.S. Cl. CPC B60P 3/0257; G06Q 10/08; G06Q 50/28; G05D 2201/0207; G01S 13/88; G05D 1/0212; G05D 1/0257; G06Q 50/10

(57) ABSTRACT

The invention discloses an unmanned vending vehicle system, comprising an order module and a remote scheduling module, wherein both the order module and the remote scheduling module are communicated and connected to the vehicle-mounted terminal via a server; the vehicle-mounted terminal comprises a vehicle management system disposed on the chassis and a commodity management system disposed on the vehicle body, and the chassis is detachably connected to the vehicle body; the vehicle management system comprises an automatic driving module; the commodity management system comprises a commodity throughput module and an access module; the automatic driving module comprises an IPC (Industrial Personal Computer), a laser radar; and a GPS module. The invention has the characteristics of saving labor power, improving freight efficiency, enhancing expansibility and saving resources.

### BACKGROUND OF THE INVENTION

### 1. Field of the Invention

The invention relates to the technical field of mobile vending, and in particular, to an unmanned vending vehicle system and the method of use thereof.

### DESCRIPTION OF THE RELATED ART

With the development of intelligence and electrification in the transportation field nowadays, some cars with special functions have appeared in our field of vision, such as mobile express delivery vehicles and mobile vending vehicles. At present, most of these types of operating vehicles require human driving and have a single function, low intelligence, and require human involvement in operations, which increases labor costs.

### SUMMARY OF THE INVENTION

The object of the invention is to provide an unmanned vending vehicle system and the method of use thereof. The invention has the characteristics of saving labor power, improving freight efficiency and saving resources.

Technical solutions of the invention: an unmanned vending vehicle system, comprising an order module and a remote scheduling module, wherein both the order module and the remote scheduling module are communicated and connected to the vehicle-mounted terminal via a server; the vehicle-mounted terminal comprises a vehicle management system disposed on the chassis and a commodity management system disposed on the vehicle body, and the chassis is detachably connected to the vehicle body; the vehicle management system comprises an automatic driving module; the commodity management system comprises a commodity throughput module and an access module; the automatic driving module comprises an IPC (Industrial Personal Computer), a laser radar, and a GPS module;

the order module is configured to bind the user information, to query information of commodity and vehicle in real time, and to make an order and payment;

the remote scheduling module is configured to acquire the vehicle position in real time through a GPS module, to control the automatic driving module, and to achieve remote scheduling;

the IPC is configured to process and make decisions on the interactive data, and to transmit the action command that the vehicle needs to perform to the corresponding vehicle execution component to realize automatic driving;

the laser radar is configured to collect environmental data around the vehicle, and to transmit the environmental data to IPC to make decisions;

the GPS module is configured to provide the vehicle position, and to match with the location on the map;

the commodity throughput module is configured to timely update and maintain the commodity information in the container of the vehicle body;

the access module is configured to verify the user identity and payment information to control the open/close of the container door of the vehicle body.

Further, the vehicle management system further comprises an energy management module, which is configured to manage the charging/discharging, equalizing maintenance, power display, and power warning of the vehicle battery.

Further, the commodity management system further comprises:

a video monitoring module, which is configured to monitor the container of the vehicle body and upload the monitoring video to the server;

an alarm module, which is configured to receive the trigger information from other modules and issue an alarm.

Further, in the unmanned vending vehicle system, the automatic driving module further comprises a camera module, which is configured to collect traffic information, traffic signal information and pedestrian and vehicle information, and to transmit the collected information to IPC to make decisions.

A method of use of the unmanned vending vehicle system is carried out as follows:

a. the remote scheduling module establishes communication with the automatic driving module of the vehicle management system on the chassis through the server, controls the automatic driving module to perform automatic driving, and transports the vehicle body on the chassis to the preset position;

b. in the preset position, the chassis removes the vehicle body, and then the remote scheduling module controls the chassis to transport the next vehicle body;

c. the order module establishes communication with the vehicle body in the preset position through the server, queries the commodity information in the container of the vehicle body, selects the commodity, and makes an order and payment;

d. after the payment, the access module controls the open of the container door of the vehicle body, and the purchased commodity can be taken out.

Specifically, in step b of the method of use of the unmanned vending vehicle system, after the chassis removes the vehicle body, the energy management module will calculate the maximum driving mileage based on the remaining power information of the battery on the chassis; when the delivery distance of the next vehicle body is greater than the maximum driving mileage, the energy management module will send an alarm to the server, and the chassis will stop moving or travel to the charging station for charging within the maximum driving mileage, then the remote scheduling module will schedule another chassis for the transportation of the next vehicle body.

Specifically, in step b of the method of use of the unmanned vending vehicle system, after the chassis removes the vehicle body, the video monitoring module will monitor the container of the vehicle body; when an abnormal condition is monitored, the video monitoring module will send the trigger information to the alarm module to issue an alarm, and the monitoring video of abnormal condition will be uploaded to the server and be saved to the memory of the commodity management system.

Specifically, in step d of the method of use of the unmanned vending vehicle system, after the purchased commodity is taken out, the commodity throughput module detects that the number of commodity labels is reduced, it will update the commodity quantity information in real time, and will judge the information of the commodity to be supplemented according to the updated commodity quantity information; the commodity throughput module uploads the information of the commodity to be supplemented to the server, and then the server transmits the information to the remote scheduling module; the remote scheduling module schedules the idle chassis to transport the replenishing vehicle body to the designated position for replenishment.

### Advantageous Effects

Compared with the prior technology, the invention provides a detachable connection structure between the chassis of the vehicle-mounted terminal and the vehicle body with the container, the chassis is provided with a vehicle management system comprising an automatic driving module, and the vehicle body is provided with a commodity management system comprising a commodity throughput module and an access module; both the vehicle management system and the commodity management system are communicated and connected to the server, and the server is respectively communicated and connected to the remote scheduling module and the order module; through the structure, the chassis and the vehicle body of the vehicle-mounted terminal are separable, the container of the vehicle body is designed according to the standardization, and various vending cabins (vehicle bodies) can be automatically connected with the chassis. The chassis uses its characteristic of autonomous driving to transport various vending cabins (vehicle bodies) to different destinations, after the transportation, the chassis is automatically separated from the vehicle body, and after the separation, the chassis is scheduled by the remote scheduling module to transport the next vehicle body, thereby realizing the effect of reusing the chassis to save resources and optimize efficiency; at the same time, the chassis of the invention is remotely scheduled by the remote scheduling module, which realizes autonomous movement of the automatic driving; therefore, the multi-functional vehicle system with autonomous movement not only saves the driver, reduces the labor cost, but also can be integrated into the urban transportation network, can be unified management and scheduling, and can effectively improve the traffic and improve the point-to-point freight efficiency, and meet the needs of intelligent development of the city.

The invention connects the order module into the commodity management system through the server. When the user purchases the commodity in the container of the vehicle body, after the user information is bound by the order module, the commodity can be selected on the order module, and the payment is made, which is simple and convenient to use.

The energy management module of the invention calculates the maximum driving mileage based on the remaining power information of the battery on the chassis, and then compares the maximum driving mileage with the delivery mileage to confirm the next work of the chassis; through this method, the scientific scheduling of the remote scheduling module is realized, and the operating efficiency and reliability of the system are further improved.

The invention can calculate the information of the commodity to be supplemented through the commodity throughput module, and the remote scheduling module schedules the idle chassis to transport the replenishing vehicle body to the designated position for replenishment; through this method, the accuracy of the replenishment is improved, and the operating efficiency of the system is further improved.

The invention has the characteristics of saving labor power, improving freight efficiency, enhancing expansibility and saving resources.

### BRIEF DESCRIPTION OF THE DRAWINGS

FIG. 1 is a schematic view illustrating the structure of the system of the invention.

### DETAILED DESCRIPTION OF THE INVENTION

The invention is further described hereinafter with reference to the drawings and embodiments, which are not to be construed as limiting the invention.

### Embodiment 1

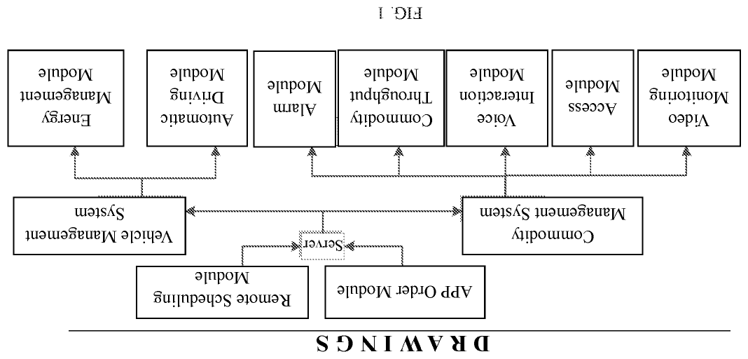

An unmanned vending vehicle system, as shown in FIG. 1, comprising

an order module and a remote scheduling module, wherein both the order module and the remote scheduling module are communicated and connected to the vehicle-mounted terminal via a server; the vehicle-mounted terminal comprises a vehicle management system disposed on the chassis and a commodity management system disposed on the vehicle body, and the chassis is detachably connected to the vehicle body; the vehicle management system comprises an automatic driving module (The software system of the automatic driving module can be used in a conventional automatic driving system, such as Autoware, Apollo of Baidu or automatic driving system of Google.); the commodity management system comprises a commodity throughput module and an access module; the automatic driving module comprises an IPC (Industrial Personal Computer), a laser radar, and a GPS module; the detachable connection structure between the chassis and the vehicle body can be performed by using a conventional hydraulic actuator, and the hydraulic actuator can realize separation between the chassis and the vehicle body;

the vehicle body is supported by the hydraulic cylinder from the ground, and the hydraulic cylinder is extended to separate the vehicle body from the chassis, then the chassis is driven out from the lower side of the vehicle body to complete separation;

the server is configured to transfer, integrate, allocate, store data, and other processing;

the order module is configured to bind the user information, to query information of commodity and vehicle in real time, and to make an order and payment; the order module can be a user APP, which is mainly used for user operation. After the user downloads and registers, the user needs to bind the required name, bank card, ID number and other information to the system as the only proof of the subsequent open of the container of the vehicle body. The user can also query commodity information, vehicle distance, location information, etc. in real time through the APP.

The remote scheduling module is configured to acquire the vehicle position in real time through a GPS module, to control the automatic driving module, to achieve remote scheduling, and to optimize operational efficiency. Specifically, the remote scheduling module is mainly used for: \textcircled{1} tracking, positioning, and monitoring the vehicle-mounted terminal in real time: tracking whether the vehicle-mounted terminal is over limit, monitoring power status, vehicle running status, real-time revenue, etc., all displayed on the electronic screen, which is convenient for the background to intuitively understand the status information of the vehicle. \textcircled{2} Command, scheduling, and integrated management: according to the data returned by the actual vehicle-mounted terminal, it can be involved in the vehicle-mounted terminal operation planning. If there is an increase in traffic in a certain area, and the vehicles in the area are fewer, which cannot meet the demand, then the nearest vehicle-mounted terminal needs to be intelligently scheduled; at the same time, for the out-of-stock vehicle bodies, it is necessary for them to return to the warehouse to replenish commodities, and the replenishment task needs to be taken over by its nearest chassis; at the same time, the remote scheduling module can also understand the traffic information in real time and plan the appropriate driving path of the vehicle-mounted terminal. \textcircled{3} Statistical analysis of data and trajectory playback: the remote scheduling module can form relevant business statistics reports on the vehicle body in the system, and play back the trajectory of the vehicle stored in the data within a specified time period, which is convenient for post analysis and processing.

The IPC is configured to process and make decisions on the interactive data, and to transmit the action command that the vehicle needs to perform to the corresponding vehicle execution component to realize automatic driving; the IPC mainly receives environmental data collected from the laser radar and/or the camera module, and then undergoes data processing to obtain characteristic information such as relative distance, relative speed, angle, and moving direction of the surrounding object and the vehicle for the IPC to make decisions; the IPC then transmits the decisions (i.e., the action command that the vehicle needs to perform) to the corresponding vehicle execution component for automatic driving;

the laser radar is configured to collect environmental data around the vehicle, and to transmit the environmental data to IPC to make decisions; the environmental data includes a group of people with special characteristics, surrounding vehicles, and the like; specifically, the laser radar scans the information around the vehicle in real time through a laser beam that rotates at a high speed to obtain environmental data;

the GPS module is configured to provide the vehicle position, and to match with the location on the map;

the commodity throughput module is configured to timely update and maintain the commodity information in the container of the vehicle body; specifically, when the user takes out one or more commodities, the commodity throughput module will update the information of the number of commodities through the decrease of the number of commodity labels, and updates the information to the server after transmitting the information to the commodity management system; the order module updates the number of commodities in real time by establishing communication with the server.

The access module is configured to verify the user identity and payment information to control the open/close of the container door of the vehicle body. The access module can only be opened normally after the user uses the order module (such as APP) or the QR code on the scanning vehicle to pass the relevant verification (mainly identity authentication); if the user does not comply with the rules and forcibly opens the container, the video monitoring module will trigger the alarm module to issue an alarm. When the user opens, if the commodity is not taken within the specified time (such as 3 seconds), the access control system will automatically close the container of the vehicle body, and the next time it needs to be re-authenticated.

The commodity management system further comprises a voice interaction module, that is, the vehicle-mounted terminal has a voice recognition function, and is mainly used to prompt the user to operate the process and provide the commodity information of the container.

The vehicle management system further comprises an energy management module, which is configured to manage the charging/discharging, equalizing maintenance, power display, and power warning of the vehicle battery, and at the same time upload the management information to the server.

The commodity management system further comprises:

a video monitoring module, which is configured to monitor the container of the vehicle body and upload the monitoring video to the server; the video in the server is periodically emptied according to requirements (such as emptied once in 15 days), which is convenient for optimization management of the memory. However, once the alarm module issues an alarm, the video captured will be stored separately in the memory of the local commodity management system of the vehicle.

an alarm module, which is configured to receive the trigger information from other modules and issue an alarm.

The automatic driving module further comprises a camera module, which is configured to collect traffic information, traffic signal information and pedestrian and vehicle information, and to transmit the collected information to IPC to make decisions.

The method of use of the unmanned vending vehicle system is carried out as follows:

a. the remote scheduling module establishes communication with the automatic driving module of the vehicle management system on the chassis through the server, controls the automatic driving module to perform automatic driving, and transports the vehicle body on the chassis to the preset position;

b. in the preset position, the chassis removes the vehicle body, and then the remote scheduling module controls the chassis to transport the next vehicle body; specifically, the separation of the chassis from the vehicle body is as follows: after the vehicle body reaches the preset position, the automatic driving module stops running and feeds back the stop signal to the server; the server sends a stop signal to the vehicle body; after the vehicle body receives the stop signal, the hydraulic cylinder is extended to support the ground, and the vehicle body is raised up, so that the vehicle body and the chassis are separated in the vertical direction, and then the chassis can be driven away from the vehicle body.

c. the order module establishes communication with the vehicle body in the preset position through the server, queries the commodity information in the container of the vehicle body, selects the commodity, and makes an order and payment;

d. after the payment, the access module controls the open of the container door of the vehicle body, and the purchased commodity can be taken out.

In step b, after the chassis removes the vehicle body, the energy management module will calculate the maximum driving mileage based on the remaining power information of the battery on the chassis; when the delivery distance of the next vehicle body is greater than the maximum driving mileage, the energy management module will send an alarm to the server, and the chassis will stop moving or travel to the charging station for charging within the maximum driving mileage, then the remote scheduling module will schedule another chassis for the transportation of the next vehicle body. Through this method, the scientific scheduling of the remote scheduling module is realized, and the operating efficiency and reliability of the system are further improved.

In step b, after the chassis removes the vehicle body, the video monitoring module will monitor the container of the vehicle body; when an abnormal condition is monitored, the video monitoring module will send the trigger information to the alarm module to issue an alarm, and the monitoring video of abnormal condition will be uploaded to the server and be saved to the memory of the commodity management system for investigation and forensics, the abnormal condition is such as forcibly opening the container, etc.

In step d, after the purchased commodity is taken out, the commodity throughput module detects that the number of commodity labels is reduced, it will update the commodity quantity information in real time, and will judge the information of the commodity to be supplemented according to the updated commodity quantity information; the commodity throughput module uploads the information of the commodity to be supplemented to the server, and then the server transmits the information to the remote scheduling module; the remote scheduling module schedules the idle chassis to transport the replenishing vehicle body to the designated position for replenishment, or the chassis directly transports the full-of-stock vehicle bodies to the designated location to replace the out-of-stock vehicle bodies. When the quantity of a certain commodity is less than 0 or the total quantity of all commodities is less than 30% of the total quantity, the commodity throughput module feeds back the information of the commodity to be supplemented to the commodity management system. Through this method, the accuracy of the replenishment is improved, and the operating efficiency of the system is further improved.

1. An unmanned vending vehicle system, comprising an order module and a remote scheduling module, wherein both the order module and the remote scheduling module are communicated and connected to the vehicle-mounted terminal via a server; the vehicle-mounted terminal comprises a vehicle management system disposed on the chassis and a commodity management system disposed on the vehicle body, and the chassis is detachably connected to the vehicle body; the vehicle management system comprises an automatic driving module; the commodity management system comprises a commodity throughput module and an access module; the automatic driving module comprises an IPC (Industrial Personal Computer), a laser radar, and a GPS module;
the order module is configured to bind the user information, to query information of commodity and vehicle in real time, and to make an order and payment;
the remote scheduling module is configured to acquire the vehicle position in real time through a GPS module, to control the automatic driving module, and to achieve remote scheduling;
the IPC is configured to process and make decisions on the interactive data, and to transmit the action command that the vehicle needs to perform to the corresponding vehicle execution component to realize automatic driving;
the laser radar is configured to collect environmental data around the vehicle, and to transmit the environmental data to IPC to make decisions;
the GPS module is configured to provide the vehicle position, and to match with the location on the map;
the commodity throughput module is configured to timely update and maintain the commodity information in the container of the vehicle body;
the access module is configured to verify the user identity and payment information to control the open/close of the container door of the vehicle body.

2. The unmanned vending vehicle system according to claim 1, wherein the vehicle management system further comprises an energy management module, which is configured to manage the charging/discharging, equalizing maintenance, power display, and power warning of the vehicle battery.

3. The unmanned vending vehicle system according to claim 1, wherein the commodity management system further comprises:
a video monitoring module, which is configured to monitor the container of the vehicle body and upload the monitoring video to the server;
an alarm module, which is configured to receive the trigger information from other modules and issue an alarm.

4. The unmanned vending vehicle system according to claim 1, wherein the automatic driving module further comprises a camera module, which is configured to collect traffic information, traffic signal information and pedestrian and vehicle information, and to transmit the collected information to IPC to make decisions.

5. A method of use of the unmanned vending vehicle system, wherein it is carried out as follows:
a. the remote scheduling module establishes communication with the automatic driving module of the vehicle management system on the chassis through the server, controls the automatic driving module to perform automatic driving, and transports the vehicle body on the chassis to the preset position;
b. in the preset position, the chassis removes the vehicle body, and then the remote scheduling module controls the chassis to transport the next vehicle body;
c. the order module establishes communication with the vehicle body in the preset position through the server, queries the commodity information in the container of the vehicle body, selects the commodity, and makes an order and payment;
d. after the payment, the access module controls the open of the container door of the vehicle body, and the purchased commodity can be taken out.

6. The method of use of the unmanned vending vehicle system according to claim 5, wherein in step b, after the chassis removes the vehicle body, the energy management module will calculate the maximum driving mileage based on the remaining power information of the battery on the chassis; when the delivery distance of the next vehicle body is greater than the maximum driving mileage, the energy management module will send an alarm to the server, and the chassis will stop moving or travel to the charging station for charging within the maximum driving mileage, then the remote scheduling module will schedule another chassis for the transportation of the next vehicle body.

7. The method of use of the unmanned vending vehicle system according to claim 5, wherein in step b, after the chassis removes the vehicle body, the video monitoring module will monitor the container of the vehicle body; when an abnormal condition is monitored, the video monitoring module will send the trigger information to the alarm module to issue an alarm, and the monitoring video of abnormal condition will be uploaded to the server and be saved to the memory of the commodity management system.

8. The method of use of the unmanned vending vehicle system according to claim 5, wherein in step d, after the purchased commodity is taken out, the commodity throughput module detects that the number of commodity labels is reduced, it will update the commodity quantity information in real time, and will judge the information of the commodity to be supplemented according to the updated commodity quantity information; the commodity throughput module uploads the information of the commodity to be supplemented to the server, and then the server transmits the information to the remote scheduling module; the remote scheduling module schedules the idle chassis to transport the replenishing vehicle body to the designated position for replenishment.
